(19) United States
(12) Patent Application Publication
(10) Pub. No.: US 2023/0269464 A1
(43) Pub. Date: Aug. 24, 2023

(54) IMAGING SYSTEM, 3D MODEL GENERATION SYSTEM, CONTROLLER, AND METHOD

(71) Applicant: Panasonic Intellectual Property Management Co., Ltd., Osaka (JP)

(72) Inventor: Hiroshi SAITO, Osaka (JP)

(21) Appl. No.: 18/308,296

(22) Filed: Apr. 27, 2023

Related U.S. Application Data
(63) Continuation of application No. PCT/JP2021/040319, filed on Nov. 2, 2021.

(30) Foreign Application Priority Data
Nov. 4, 2020 (JP) 2020-184682

(51) Int. Cl. H04N 23/66; H04N 23/71; H04N 23/45; H04N 23/74; H04N 23/73; H04N 23/90

(52) U.S. Cl. CPC H04N 23/66; H04N 23/71; H04N 23/45; H04N 23/74; H04N 23/73; H04N 23/90

(57) ABSTRACT

An imaging system includes a plurality of imaging devices that include two or more imaging devices, and a controller that communicates with the plurality of imaging devices. Each of the plurality of imaging devices includes a reception unit and an imaging setting unit. Each of the two or more imaging devices includes a housing, a sensor, and a transmission unit. The imaging setting unit performs a setting regarding the imaging based on the common set value acquired by the reception unit. The sensor detects external brightness of the housing. The controller includes an acquisition unit, a setting unit, and an output unit. The acquisition unit acquires information regarding a detection result of the sensor. The setting unit determines a common set value to be applied to the plurality of imaging devices based on the information regarding the detection result acquired by the acquisition unit.

### TECHNICAL FIELD

The present disclosure relates to generally an imaging system, a 3D model generation system, a controller, a method, and a program. More specifically, the present disclosure relates to an imaging system including a plurality of imaging devices and a controller, a 3D model generation system including the imaging system, a controller used in the imaging system, and a method and a program used in the controller.

### BACKGROUND ART

A digital camera system (imaging system) described in PTL 1 includes a plurality of digital cameras (imaging devices) and an operation control device (controller). The operation control device groups the plurality of digital cameras into a plurality of groups, and simultaneously transmits a control command to each of the digital cameras belonging to an identical group. Each of the digital cameras belonging to the identical group executes a common operation corresponding to the control command

### CITATION LIST

### Patent Literature

PTL 1: Unexamined Japanese Patent Publication No. 2006-217357

### SUMMARY OF THE INVENTION

In the digital camera system described in PTL 1, for example, a place where a part of the digital cameras is installed may be darker than a place where another digital camera is installed. In this case, there is a difference between brightness of an image generated by a part of the digital cameras and brightness of an image generated by the other digital camera. As described above, there may be a difference in properties of a plurality of images generated by a plurality of digital cameras due to an environment in which the plurality of digital cameras are installed, a difference in characteristics regarding imaging of the plurality of digital cameras, and the like.

An object of the present disclosure is to provide an imaging system, a 3D model generation system, a controller, and a program capable of setting properties of a plurality of images generated by a plurality of imaging devices close to each other.

An imaging system according to one aspect of the present disclosure includes a plurality of imaging devices including two or more imaging devices, and a controller. The controller communicates with the plurality of imaging devices. Each of the plurality of imaging devices includes a reception unit and an imaging setting unit. The reception unit acquires, from the controller, a common set value regarding imaging The imaging setting unit performs a setting regarding the imaging based on the common set value acquired by the reception unit. Each of the two or more imaging devices further includes a housing, a sensor, and a transmission unit. The sensor detects external brightness of the housing. The transmission unit outputs information regarding a detection result of the sensor to the controller. The controller includes an acquisition unit, a setting unit, and an output unit. The acquisition unit acquires the information regarding the detection result of the sensor of each of the two or more imaging devices. The setting unit determines the common set value to be applied to the plurality of imaging devices based on the information regarding the detection result acquired by the acquisition unit. The output unit outputs the common set value determined by the setting unit to the plurality of imaging devices.

An imaging system according to another aspect of the present disclosure includes a plurality of imaging devices including two or more imaging devices, and a controller. The controller communicates with the plurality of imaging devices. Each of the two or more imaging devices includes a housing, a sensor, and a transmission unit. The sensor detects external brightness of the housing. The transmission unit outputs information regarding a detection result of the sensor to the controller. The controller includes an acquisition unit and a brightness adjustment unit. The acquisition unit acquires the information regarding the detection result of the sensor of each of the two or more imaging devices. The brightness adjustment unit adjusts brightness of each of a plurality of illumination devices that illuminates a space captured by the plurality of imaging devices based on the information regarding the detection result acquired by the acquisition unit.

A 3D model generation system according to another aspect of the present disclosure includes the imaging system according to any one of the above aspects and a 3D generation unit. The 3D generation unit generates a 3D model of an imaging target of the plurality of imaging devices by using pieces of information on a plurality of images generated by the plurality of imaging devices of the imaging system.

A controller according to still another aspect of the present disclosure includes an acquisition unit, a setting unit, and an output unit. The acquisition unit acquires information regarding a detection result of a sensor that detects external brightness and the sensor is included in each of two or more imaging devices among the plurality of imaging devices. The setting unit determines a common set value regarding imaging to be applied to the plurality of imaging devices based on the information regarding the detection result acquired by the acquisition unit. The output unit outputs the common set value determined by the setting unit to the plurality of imaging devices.

A method according to still another aspect of the present disclosure includes acquisition processing, setting processing, and output processing. The acquisition processing is processing of acquiring information regarding a detection result of a sensor that detects external brightness and the sensor is included in each of two or more imaging devices among the plurality of imaging devices. The setting processing is processing of determining a common set value regarding imaging to be applied to the plurality of imaging devices based on the information regarding the detection result acquired in the acquisition processing. The output processing is processing of outputting the common set value determined in the setting processing to the plurality of imaging devices.

A program according to still another aspect of the present disclosure is a program causing one or more processors to execute the method according to the aspect described above.

The present disclosure has an advantage that properties of a plurality of images generated by a plurality of imaging devices can be set to be close to each other.

### BRIEF DESCRIPTION OF THE DRAWINGS

FIG. 1 is a block diagram of an imaging system according to a first exemplary embodiment.

FIG. 2 is a block diagram of an imaging device of the imaging system.

FIG. 3 is a schematic diagram illustrating a usage example of the imaging system.

FIG. 4 is a flowchart illustrating an operation example of the imaging system.

FIG. 5 is a frequency distribution diagram of a temporary set value of a shutter speed in the imaging system.

FIG. 6 is a frequency distribution diagram of a temporary set value of an F-number in the imaging system.

FIG. 7 is a frequency distribution diagram of a temporary set value of a shutter speed in an imaging system according to a fourth modification.

FIG. 8 is a block diagram illustrating an imaging system according to a second exemplary embodiment.

### DESCRIPTION OF EMBODIMENT

### First Exemplary Embodiment

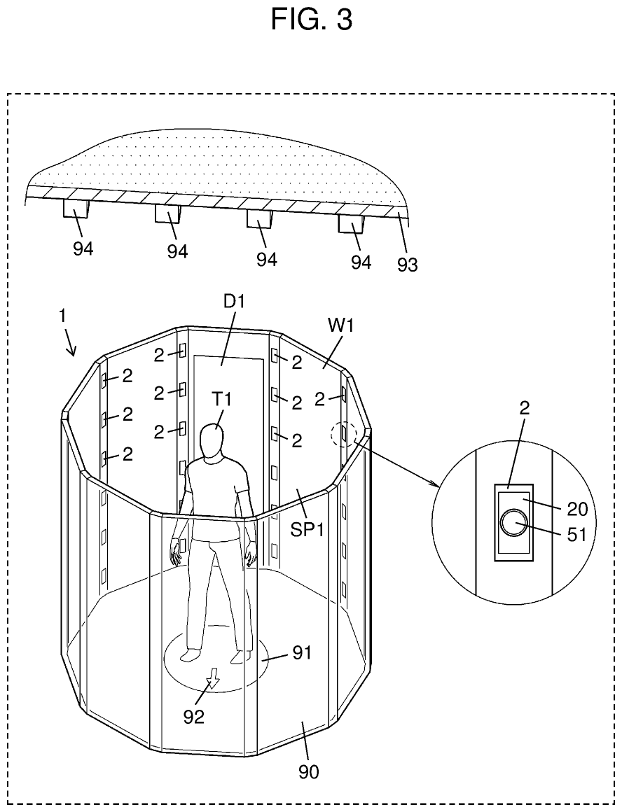

Hereinafter, an imaging system, a 3D model generation system, a controller, and a program according to a first exemplary embodiment will be described with reference to the drawings. Incidentally, the following exemplary embodiment is merely one of various exemplary embodiments of the present disclosure. Provided that an object of the present disclosure can be achieved, the following exemplary embodiment can be modified in various ways in accordance with design and the like. In addition, FIG. 3 is a schematic diagram, and ratios in size and thickness of each component in the drawing is not necessarily reflected in an actual dimensional ratio.

(Outline)

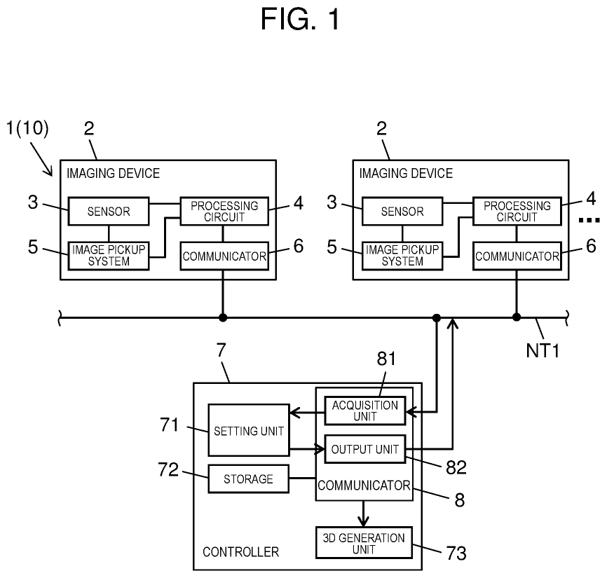

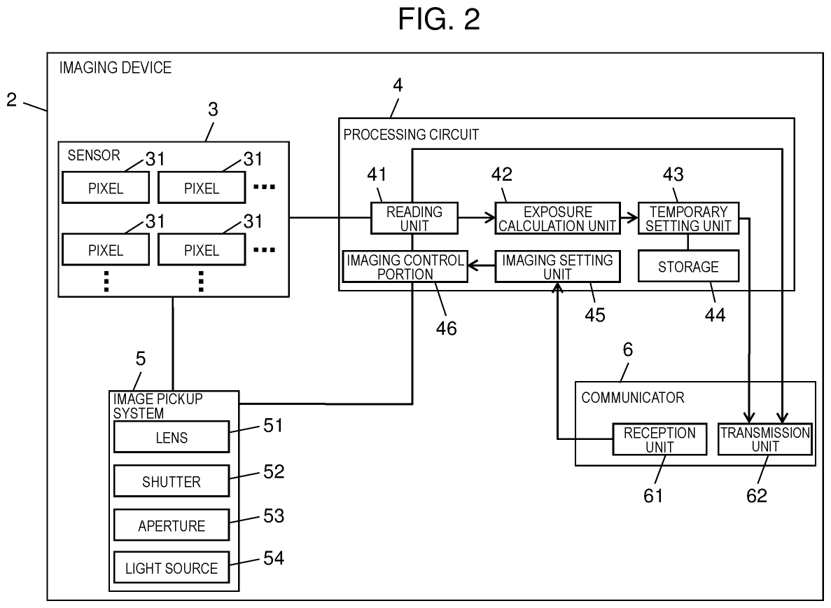

As illustrated in FIGS. 1 and 2, imaging system 1 of the present exemplary embodiment includes a plurality of imaging devices 2 and controller 7. Controller 7 communicates with the plurality of imaging devices 2. Each of the plurality of imaging devices 2 includes reception unit 61 and imaging setting unit 45. Reception unit 61 acquires a set value regarding imaging from controller 7 Imaging setting unit 45 performs setting regarding imaging based on the set value acquired by reception unit 61. Each of two or more imaging devices 2 (all of the plurality of imaging devices 2 in the present exemplary embodiment) among the plurality of imaging devices 2 further includes housing 20 (see FIG. 3), sensor 3, and transmission unit 62. Sensor 3 detects external brightness of housing 20. Transmission unit 62 outputs information on a detection result of sensor 3 to controller 7. Controller 7 includes acquisition unit 81, setting unit 71, and output unit 82. Acquisition unit 81 acquires the information on the detection result of sensor 3 of each of the two or more imaging devices 2. Setting unit 71 determines a common set value to be applied to the plurality of imaging devices 2 based on the information on the detection result acquired by acquisition unit 81. Output unit 82 outputs the set value determined by setting unit 71 to the plurality of imaging devices 2.

According to the present exemplary embodiment, since the common set value regarding imaging is applied to the plurality of imaging devices 2, imaging conditions of the plurality of imaging devices 2 can be set to be close to each other. As a result, properties (for example, brightness) of a plurality of images generated by the plurality of imaging devices 2 can be set to be close to each other. That is, it is possible to relatively reduce differences between properties of images generated by some imaging devices 2 and properties of images generated by other imaging devices 2.

Imaging system 1 is applied to, for example, 3D model generation system 10 (3D scanner). 3D model generation system 10 generates a three-dimensional (3D) model of imaging target T1 (subject) (see FIG. 3) by using pieces of information on the plurality of images generated by the plurality of imaging devices 2. Since the properties of the plurality of images generated by the plurality of imaging devices 2 become close to each other by using imaging system 1 of the present exemplary embodiment, a relatively high-quality 3D model can be generated.

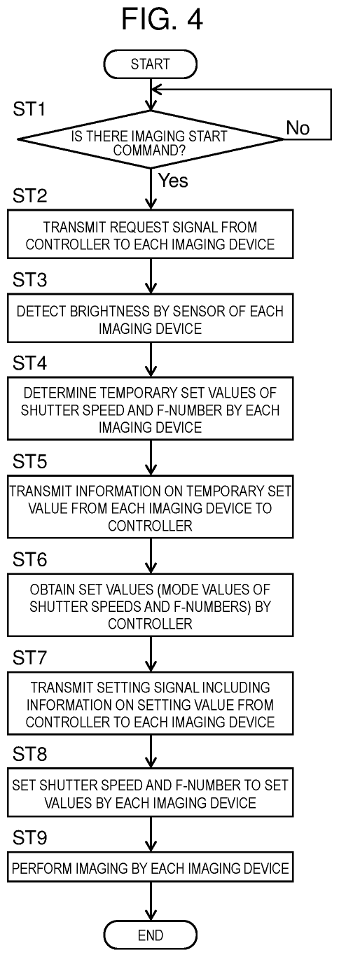

Hereinafter, an example of an operation of capturing imaging target T1 by imaging system 1 will be described with reference to FIG. 4. The flowchart illustrated in FIG. 4 is merely an example of the operation of imaging system 1, and an order of kinds of processing may be appropriately changed, or the processing may be appropriately added or omitted.

First, controller 7 waits for an input of an imaging start command (step ST1). The imaging start command is a command serving as a trigger causing the plurality of imaging devices 2 to perform imaging. The imaging start command is input to controller 7 in accordance with an operation of an operator, for example.

When the imaging start command is input to controller 7 (step ST1: Yes), controller 7 transmits a request signal to each of the plurality of imaging devices 2 (step ST2).

When the request signal is received, each of the plurality of imaging devices 2 outputs the information regarding the detection result of sensor 3 to controller 7. More specifically, when each of the plurality of imaging devices 2 receives the request signal, first, sensor 3 detects the external brightness (illuminance) of housing 20 (step ST3). Subsequently, each of the plurality of imaging devices 2 determines a temporary set value of a shutter speed and a temporary set value of an F-number (aperture value) based on a detected value of the brightness detected by sensor 3 (step ST4). The temporary set value of the shutter speed is a set value of the shutter speed optimum for imaging device 2 in a case where the plurality of imaging devices independently perform imaging. The temporary set value of the F-number is a set value of the F-number optimum for imaging device 2 in a case where the plurality of imaging devices independently perform imaging. Each of the plurality of imaging devices 2 outputs, as the information regarding the detection result of sensor 3, the temporary set value of the shutter speed and the temporary set value of the F-number to controller 7 (step ST5).

Controller 7 acquires the temporary set value of the shutter speed and the temporary set value of the F-number from each of the plurality of imaging devices 2 (acquisition processing). That is, controller 7 acquires temporary set values of a plurality of shutter speeds corresponding one-to-one to the plurality of imaging devices 2 and temporary set values of a plurality of F-numbers corresponding one-to-one to the plurality of imaging devices 2. Controller 7 obtains a mode value of the temporary set values of the plurality of shutter speeds, and sets the obtained mode value as the set value of the shutter speed (step ST6: setting processing). In addition, controller 7 obtains a mode value of the temporary set values of the plurality of F-numbers, and sets the obtained mode value as the set value of the F-number (step ST6: setting processing). Controller 7 transmits a setting signal including information on the set value of the shutter speed and the set value of the F-number to each of the plurality of imaging devices 2 (step ST7: output processing). A plurality of setting signals transmitted to the plurality of imaging devices 2 are the same signal.

Each of the plurality of imaging devices 2 acquires the information on the set value of the shutter speed and the set value of the F-number included in the setting signal. Each of the plurality of imaging devices 2 adjusts the shutter speed and the F-number such that the shutter speed and the F-number of imaging device become the set values acquired from controller 7 (step ST8). As a result, the shutter speed is the same among the plurality of imaging devices 2, and the F-number is the same among the plurality of imaging devices 2.

Each of the plurality of imaging devices 2 captures imaging target T1 after adjusting the shutter speed and the F-number (step ST9). Timings at which the plurality of imaging devices 2 capture imaging target T1 are controlled by controller 7. The timings at which the plurality of imaging devices 2 capture imaging target T1 are, for example, the same.

As described above, each of the plurality of imaging devices 2 captures imaging target T1. In addition, although not illustrated in the flowchart of FIG. 4, each of the plurality of imaging devices 2 transmits information on an image (image signal) generated by capturing imaging target T1 to controller 7. Controller 7 can generate a 3D model of imaging target T1 by using the pieces of information on the plurality of images acquired from the plurality of imaging devices 2. Note that a function of generating the 3D model may be included in a device different from controller 7.

(Details)

Hereinafter, a configuration of imaging system 1 will be described in more detail.

(1) Imaging Device

As illustrated in FIG. 2, each of the plurality of imaging devices 2 includes sensor 3, processing circuit 4, image pickup system 5, and communicator 6.

(1.1) Sensor

Sensor 3 is, for example, a two-dimensional image sensor such as a charge coupled device (CCD) image sensor or a complementary metal oxide semiconductor (CMOS) image sensor. Sensor 3 is a device for detecting the external brightness of housing 20 (see FIG. 3), and is also a device for capturing imaging target T1 and generating an image.

Sensor 3 includes a plurality of pixels 31. The plurality of pixels 31 are arranged in a two-dimensional array. Light may be incident on each of the plurality of pixels 31 only during an exposure period. Each of the plurality of pixels 31 includes a photoelectric conversion portion. The photoelectric conversion portion converts photons (incident light) into electric charges. The electric charges converted from the photons by the photoelectric conversion portion are output, as an output signal, to processing circuit 4 in the form of a voltage.

(1.2) Image Pickup System

Image pickup system 5 includes lens 51, shutter 52, aperture 53, and light source 54. Image pickup system 5 is mechanically controlled when imaging device 2 captures imaging target T1. Lens 51 directs light incident on sensor 3 from the outside of housing 20 (see FIG. 3). Shutter 52 is opened during the exposure period of sensor 3 to allow the light incident on sensor 3 to pass therethrough, and blocks the light incident on sensor 3 during other periods. Aperture 53 adjusts the amount of light incident on sensor 3 through shutter 52. Light source 54 irradiates imaging target T1 when flash photographing is performed by using imaging device 2. In the present exemplary embodiment, light source 54 is not turned on, and flash photographing is performed by using a light source outside imaging device 2.

(1.3) Processing Circuit

Processing circuit 4 includes reading unit 41, exposure calculation unit 42, temporary setting unit 43, storage 44, imaging setting unit 45, and imaging control portion 46. Note that reading unit 41, exposure calculation unit 42, temporary setting unit 43, imaging setting unit 45, and imaging control portion 46 merely indicate functions realized by processing circuit 4, and do not necessarily indicate substantial configurations.

Processing circuit 4 includes a computer system having one or more processors and memories. A processor of the computer system executes a program recorded in the memory of the computer system, and thus, a function of at least a part (specifically, reading unit 41, exposure calculation unit 42, temporary setting unit 43, imaging setting unit 45, and imaging control portion 46) of processing circuit 4 is realized. The program may be recorded in the memory, may be provided through a telecommunication line such as the Internet, or may be recorded in a non-transitory recording medium such as a memory card. In addition, storage 44 may also serve as the memory of processing circuit 4.

Processing circuit 4 has a photometric mode and an imaging mode as operation modes. In the photometric mode, processing circuit 4 obtains the temporary set value of the shutter speed and the temporary set value of the F-number based on the output signal (detection result) of sensor 3, and transmits the temporary set value of the shutter speed and the temporary set value of the F-number to controller 7 via communicator 6. In the imaging mode, processing circuit 4 generates an image signal including information on an image in which imaging target T1 appears based on the output signal of sensor 3.

Reading unit 41 reads (acquires) output signals from the plurality of pixels 31 of sensor 3. Reading unit 41 reads the output signals in a time-division manner for the plurality of pixels 31. More specifically, reading unit 41 causes the plurality of pixels 31 arranged in the two-dimensional array to output the output signals at different timings for every row.

When the operation mode of processing circuit 4 is the imaging mode, reading unit 41 preferably reads the output signals from all pixels 31 among the plurality of pixels 31 of sensor 3. In the imaging mode, the output signals read by reading unit 41 are output as image signals to controller 7 via communicator 6.

When the operation mode of processing circuit 4 is the photometric mode, reading unit 41 may read the output signals from some pixels 31 of the plurality of pixels 31 of sensor 3. For example, in the photometric mode, reading unit 41 may read the output signals from two or more pixels 31 positioned within a predetermined range including a center among the plurality of pixels 31. In the photometric mode, the output signals read by reading unit 41 are output to exposure calculation unit 42.

Alternatively, when the operation mode of processing circuit 4 is the photometric mode, reading unit 41 may read the output signals from all pixels 31 among the plurality of pixels 31 of sensor 3.

In the photometric mode, the output signal of each of the plurality of pixels 31 read by reading unit 41 is input to exposure calculation unit 42. That is, in the photometric mode, the plurality of output signals are input to exposure calculation unit 42. Exposure calculation unit 42 performs predetermined processing on the plurality of output signals. A value (hereinafter, referred to as a “brightness value”) obtained by predetermined processing by exposure calculation unit 42 is a value corresponding to the external brightness of housing 20 detected by sensor 3. The predetermined processing is, for example, processing of obtaining an average value of the plurality of output signals. Note that the predetermined processing may be, for example, processing of weighting each of the plurality of output signals and obtaining an average value of products of the output signals and the corresponding weights.

In the photometric mode, temporary setting unit 43 determines a temporary set value regarding imaging based on the detection result of sensor 3. The temporary set value corresponds to the information on the detection result of sensor 3. More specifically, temporary setting unit 43 determines the temporary set value based on the brightness value obtained by exposure calculation unit 42. For example, storage 44 of processing circuit 4 stores a table indicating a correspondence between the brightness value and the temporary set value, and temporary setting unit 43 determines the temporary set value by referring to the table. Note that temporary setting unit 43 is not limited to determining the temporary set value by referring to the table. For example, temporary setting unit 43 may obtain the temporary set value from the brightness value by using a predetermined arithmetic expression.

The temporary set values include the temporary set value of the shutter speed and the temporary set value of the F-number. The temporary set value of the shutter speed is a value that defines the shutter speed of imaging device 2. The temporary set value of the F-number is a value that defines the F-number of imaging device 2.

As described above, the temporary set value of the shutter speed is the set value of the shutter speed optimal for imaging device 2 in a case where the plurality of imaging devices 2 independently perform imaging, and the temporary set value of the F-number is the set value of the F-number optimal for the imaging device in a case where the plurality of imaging devices independently perform imaging. A relationship between the brightness value and each temporary set value depends on, for example, a length of the exposure period, sensitivity of each of the plurality of pixels 31, sizes of the plurality of pixels 31, characteristics of lens 51, and the like. Temporary setting unit 43 can obtain the temporary set value from the brightness value by appropriately referring to these pieces of information.

Temporary setting unit 43 outputs, as the information on the detection result of sensor 3, the temporary set value to controller 7 via communicator 6. When the temporary set value is output from each of the plurality of imaging devices 2 to controller 7, controller 7 determines the set value regarding imaging and outputs the set value to the plurality of imaging devices 2.

Imaging setting unit 45 performs the setting regarding imaging based on the set value acquired from controller 7. The set value includes a brightness set value regarding brightness of an image generated by capturing in each of the plurality of imaging devices 2. Thus, the setting regarding imaging includes a setting that affects brightness of an image generated by capturing.

More specifically, the set value includes a shutter speed set value that defines the shutter speed of imaging device 2 and an F-number set value that defines the F-number. The setting regarding imaging executed by imaging setting unit 45 includes a setting regarding the shutter speed of imaging device 2 and a setting regarding the F-number. That is, imaging setting unit 45 instructs imaging control portion 46 to set the shutter speed of imaging device 2 to be equal to the shutter speed set value and set the F-number of imaging device 2 to be equal to the F-number set value. Imaging control portion 46 controls image pickup system 5 such that the shutter speed and the F-number designated by imaging setting unit 45 are realized.

(1.4) Communicator

Communicator 6 includes a communication interface for communicating with controller 7. Communicator 6 can communicate with controller 7 via a communication interface. The case where “communicator can communicate with controller” in the present disclosure means that information can be exchanged directly or indirectly via a network, a repeater, or the like by an appropriate communication method of wired communication or wireless communication. In the present exemplary embodiment, communicator 6 exchanges signals with controller 7 via wireless communication network NT1 (see FIG. 1).

Communicator 6 includes reception unit 61 and transmission unit 62. Reception unit 61 receives a signal from controller 7. Transmission unit 62 transmits a signal to controller 7. Note that reception unit 61 and transmission unit 62 merely indicate functions realized by communicator 6, and do not necessarily indicate substantial configurations. Thus, a communication interface that functions as reception unit 61 may also serve as transmission unit 62, or may be provided separately from a communication interface that functions as transmission unit 62.

(2) Controller

As illustrated in FIG. 1, controller 7 includes setting unit 71, storage 72, 3D generation unit 73, and communicator 8. Note that setting unit 71 and 3D generation unit 73 merely indicate functions realized by controller 7, and do not necessarily indicate substantial configurations.

Controller 7 includes a computer system having one or more processors and memories. A processor of the computer system executes a program recorded in the memory of the computer system, and thus, a function of at least a part (specifically, setting unit 71 and 3D generation unit 73) of controller 7 is realized. The program may be recorded in the memory, may be provided through a telecommunication line such as the Internet, or may be recorded in a non-transitory recording medium such as a memory card. In addition, storage 72 may also serve as a memory of controller 7. At least a part of the functions of controller 7 may be realized by a server.

(2.1) Setting Unit

Setting unit 71 acquires the information regarding the detection result of sensor 3 of each imaging device 2 from the plurality of imaging devices 2 via communicator 8. More specifically, setting unit 71 acquires the temporary set values (the temporary set value of the shutter speed and the temporary set value of the F-number) as the information regarding the detection result of sensor 3. Since the temporary set value is output from each of the plurality of imaging devices 2, setting unit 71 acquires a plurality of temporary set values of the shutter speed and acquires a plurality of temporary set values of the F-number. Setting unit 71 determines set values regarding imaging of the plurality of imaging devices 2 based on the plurality of temporary set values.

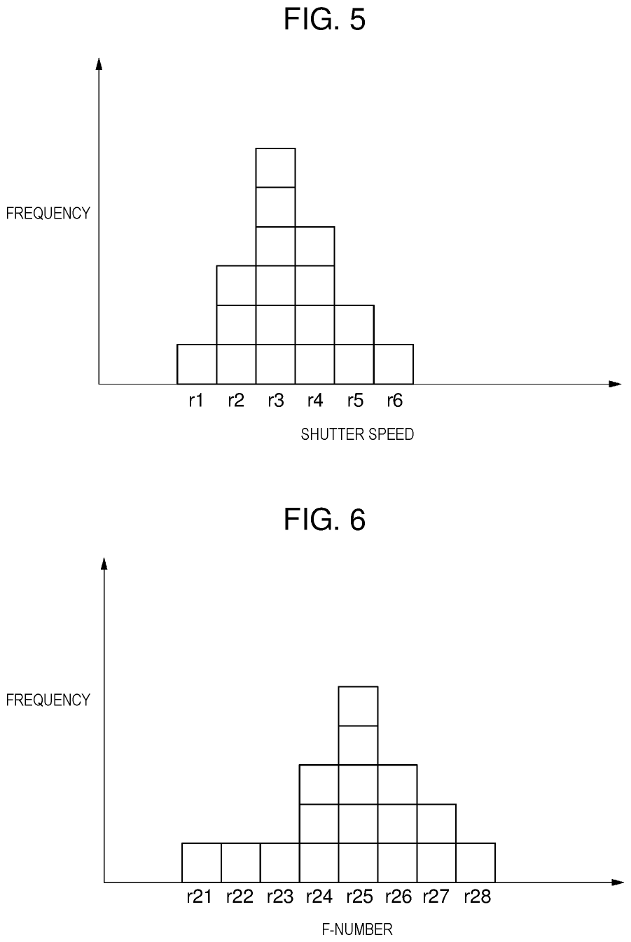

Setting unit 71 sets the mode value of the plurality of temporary set values as the set value. Hereinafter, an example of processing in which setting unit 71 determines the set value will be described with reference to FIGS. 5 and 6.

A horizontal axis in FIG. 5 represents the temporary set value of the shutter speed. Each of ranges r1 to r6 is a range of the temporary set value of the shutter speed. A vertical axis in FIG. 5 represents a frequency of each of ranges r1 to r6. When ranges r1 to r3 are exemplified, range r1 is a range in which the temporary set value (of the shutter speed) is more than or equal to 0.2 [ms] and less than 0.3 [ms], range r2 is a range in which the temporary set value is more than or equal to 0.3 [ms] and less than 0.4 [ms], and range r3 is a range in which the temporary set value is more than or equal to 0.4 [ms] and less than 0.5 [ms]. In FIG. 5, since the number of imaging devices 2 whose temporary set values are values within range r1 is one, the frequency of range r1 is one. The frequencies of ranges r2, r3, r4, r5, and r6 are 3, 6, 4, 2, and 1 in order.

The mode value is a value having a largest frequency. Setting unit 71 sets the mode value of the plurality of temporary set values as the set value. In FIG. 5, since the frequency of range r3 is the largest, setting unit 71 sets the set value of the shutter speed to a value corresponding to range r3. For example, setting unit 71 sets an intermediate value (0.45 [ms]) between an upper limit value and a lower limit value of range r3 as the set value of the shutter speed.

A horizontal axis in FIG. 6 represents the temporary set value of the F-number. Each of ranges r21 to r28 is a range of the temporary set value of the F-number. A vertical axis in FIG. 6 represents a frequency of each of ranges r21 to r28. In FIG. 6, since the frequency of range r25 is the largest, setting unit 71 sets the set value of the F-number to a value corresponding to range r25. For example, setting unit 71 sets an intermediate value between an upper limit value and a lower limit value of range r25 as the set value of the F-number.

(2.2) Storage

Referring back to FIG. 1, a configuration of controller 7 will be continuously described.

Storage 72 stores various kinds of information. Storage 72 stores, for example, information on an image included in the image signal generated by each imaging device 2 and transmitted to controller 7.

Storage 72 stores identification information on each imaging device 2 and positional information of each imaging device 2 in association with each other. Each of the plurality of imaging devices 2 transmits the information on the image to controller 7 together with the identification information of the imaging device. Storage 72 stores the information on the image acquired from each imaging device 2 in association with the positional information of imaging device 2 that has generated the information on the image.

Note that the pieces of positional information of the plurality of imaging devices 2 may be stored in advance in storage 72 or may be acquired from the plurality of imaging devices 2.

(2.3) 3D Generation Unit

3D generation unit 73 generates 3D models of imaging targets T1 of the plurality of imaging devices 2 by using the pieces of information on the plurality of images generated by the plurality of imaging devices 2.

3D model generation system 10 includes at least imaging system 1 and 3D generation unit 73. In the present exemplary embodiment, controller 7 of imaging system 1 includes 3D generation unit 73, but a device outside imaging system 1 may include 3D generation unit 73.

3D model generation system 10 of the present exemplary embodiment can generate a 3D model of a person as imaging target T1 (see FIG. 3) and can generate an avatar based on the generated 3D model. The “avatar” in the present disclosure is a character displayed in a virtual space as a virtual self of imaging target T1 (person) in a real space. 3D model generation system 10 generates an avatar that simulates imaging target T1. The avatar is displayed in the virtual space.

The plurality of imaging devices 2 are installed at different positions to surround imaging target T1, and capture imaging target T1 from different angles. As a result, 3D generation unit 73 acquires the pieces of information on the plurality of images (still images) obtained by capturing imaging target T1 from various angles.

3D generation unit 73 generates the 3D model of imaging target T1 based on the pieces of information on the plurality of images acquired from the plurality of imaging devices 2. Specifically, 3D generation unit 73 calculates coordinates of a target point in a basic space that is a three-dimensional virtual space for each of all target points of all the images. Here, 3D generation unit 73 acquires a distance from imaging device 2 to the target point in the case of being projected onto the basic space by acquiring an imaging result in each imaging device 2. In addition, 3D generation unit 73 acquires a distance between adjacent imaging devices 2 in the case of being projected onto the basic space by acquiring positional information of each imaging device 2 in the real space. 3D generation unit 73 calculates the coordinates of the target point in the basic space based on the distance by a principle of triangulation. 3D generation unit 73 generates the 3D model of imaging target T1 based on the coordinates of all the target points in the basic space.

Subsequently, 3D generation unit 73 generates a texture to be affixed to the 3D model based on the pieces of information on the plurality of images acquired from the plurality of imaging devices 2. Here, the texture includes a texture corresponding to clothes worn by imaging target T1 in addition to a texture corresponding to the skin of imaging target T1. 3D generation unit 73 affixes the generated texture on the 3D model.

Subsequently, 3D generation unit 73 executes rigging on the 3D model. In the rigging, 3D generation unit 73 executes skinning or the like including setting of a skeleton, setting of inverse kinematics (IK) and/or forward kinematics (FK), and adjustment of a weight on the 3D model. As a result, the avatar of imaging target T1 capable of performing various motions is generated.

As described above, in the present exemplary embodiment, 3D model generation system 10 can automatically generate the avatar of imaging target T1 based on the pieces of information of the plurality of images generated by capturing the entire body of imaging target T1 by the plurality of imaging devices 2.

In addition, 3D model generation system 10 may acquire motion data unique to each imaging target T1 by performing motion capture on imaging target T1. In a case where motion data is applied to the avatar, it is possible to cause the avatar to perform a motion corresponding to motion data in the virtual space.

(2.4) Communicator

Communicator 8 includes a communication interface for communicating with the plurality of imaging devices 2 (communicator 6: see FIG. 1). Communicator 8 can communicate with the plurality of imaging devices 2 via a communication interface. In the present exemplary embodiment, communicator 8 exchanges signals with the plurality of imaging devices 2 via wireless communication network NT1.

Communicator 8 includes acquisition unit 81 and output unit 82. Acquisition unit 81 receives signals from the plurality of imaging devices 2. Output unit 82 transmits signals to the plurality of imaging devices 2. Note that acquisition unit 81 and output unit 82 merely indicate functions realized by communicator 8, and do not necessarily indicate substantial configurations. Thus, a communication interface that functions as acquisition unit 81 may also serve as acquisition unit 81, or may be provided separately from a communication interface that functions as output unit 82.

(3) Installation Example of Plurality of Imaging Devices

Imaging system 1 includes, for example, several tens to several hundreds of imaging devices 2. As illustrated in FIG. 3, for example, the plurality of imaging devices 2 are embedded in wall W1 having a cylindrical shape to capture imaging target T1 in a space surrounded by wall W1. Door D1 through which a person as imaging target T1 enters and exits is provided in wall W1.

A predetermined number (six in FIG. 3) of imaging devices 2 are arranged in a row in a vertical direction. In FIG. 3, a plurality of rows including a predetermined number of imaging devices 2 are arranged to surround imaging target T1. As viewed from above, the plurality of rows are annularly arranged.

Enclosure 91 indicating a guide of the position of imaging target T1 and arrow 92 indicating a guide of an orientation of imaging target T1 are displayed on floor 90.

Wall W1 is independent of ceiling 93. That is, a wall supporting ceiling 93 is present separately from wall W1. Of course, wall W1 may support ceiling 93.

A plurality of (four in FIG. 3) illumination devices 94 are arranged on ceiling 93. The plurality of illumination devices 94 illuminate space SP1 captured by the plurality of imaging devices 2. That is, the plurality of illumination devices 94 illuminate imaging target T1 and a space around imaging target T1. The plurality of illumination devices 94 illuminates space SP1 to suppress unevenness in brightness of a surface of imaging target T1 to be less than or equal to a predetermined value.

Note that an aspect of the present exemplary embodiment is not limited to the aspect in which space SP1 is illuminated from above by the plurality of illumination devices 94, and for example, illumination devices may also be installed on floor 90 and wall W1. In addition, wall W1 may have translucency, and space SP1 may be illuminated by a plurality of illumination devices arranged outside wall W1.

(4) Imaging Method

When a person who is imaging target T1 is captured by the plurality of imaging devices 2, imaging target T1 stands inside enclosure 91 in an orientation in which an orientation indicated by arrow 92 is the front. In order to capture the entire body of imaging target T1, imaging target T1 stands still with an arm separated from a body.

In this state, the operator inputs the imaging start command to controller 7 (step ST1 in FIG. 4: Yes). By doing this, controller 7 starts a countdown until the start of imaging. For example, controller 7 notifies the remaining number of seconds until the start of imaging by voice.

When the imaging start command is input to controller 7, as described above, signals are exchanged between controller 7 and the plurality of imaging devices 2, and thus, settings regarding imaging of the plurality of imaging devices 2 are performed. Thereafter, when the countdown becomes zero, the plurality of imaging devices 2 capture imaging target T1. As a result, an image is generated in each of the plurality of imaging devices 2, and 3D generation unit 73 of controller 7 generates the 3D model of imaging target T1 by using the pieces of information on the plurality of images acquired from the plurality of imaging devices 2.

Note that, as a method of inputting the imaging start command to controller 7 by the operator, in a case where controller 7 has a configuration in which an operation of an operator of as a computer or a smartphone is received, controller 7 may be operated to input the imaging start command In addition, in a case where controller 7 is realized by a server, a terminal including a software application for inputting the imaging start command to controller 7 may be separately provided, and the operator may operate the terminal to input the imaging start command from the terminal.

Since properties (for example, brightness) of the plurality of images generated by the plurality of imaging devices 2 become close to each other by using imaging system 1 (3D model generation system 10) of the present exemplary embodiment, a relatively high-quality 3D model can be generated.

(Modifications)

Hereinafter, modifications of the first exemplary embodiment will be described. The same reference marks are given to the same components as the components of the first exemplary embodiment, and the description thereof will be omitted. In addition, the following modifications may be applied in appropriate combination.

(First Modification)

In the first exemplary embodiment, imaging setting unit 45 of each of the plurality of imaging devices 2 performs the setting regarding imaging based on the set value acquired by reception unit 61. Here, the set value may include a color set value regarding a color of the image generated by imaging in each of the plurality of imaging devices 2. Specifically, the color set value may include a set value of white balance.

For example, temporary setting unit 43 of each of the plurality of imaging devices 2 determines a temporary set value of the white balance based on the detection result of sensor 3. The temporary set value of the white balance is a set value of the white balance optimum for imaging device 2 in a case where the plurality of imaging devices independently perform imaging Setting unit 71 of controller 7 acquires a plurality of (white balance) temporary set values from the plurality of imaging devices 2, sets a mode value of the plurality of temporary set values as the set value of the white balance, and transmits the set value of the white balance to the plurality of imaging devices 2. Imaging setting unit 45 of each of the plurality of imaging devices 2 instructs imaging control portion 46 to set the white balance of imaging device 2 to be equal to the set value of the white balance. Imaging control portion 46 performs image processing on the image signal read by reading unit 41 such that the white balance designated by imaging setting unit 45 is realized. As a result, color tones of the plurality of images generated by the plurality of imaging devices 2 can be set to be close to each other.

In addition, the set value may include an exposure set value that defines an exposure of imaging device 2. The exposure is defined as a product of the shutter speed and the F-number. Imaging setting unit 45 of imaging device 2 may determine the shutter speed and the F-number such that the exposure of imaging device 2 is equal to the exposure set value Imaging control portion 46 may control image pickup system 5 such that the shutter speed and the F-number determined by imaging setting unit 45 are realized.

In addition, the set value may include a gain set value that defines a gain of imaging device 2. Imaging setting unit 45 of imaging device 2 instructs imaging control portion 46 to set the gain of imaging device 2 to be equal to the gain set value. Imaging control portion 46 adjusts a gain to amplify the image signal read by reading unit 41 with a gain designated by imaging setting unit 45. In a broad sense, although the adjustment of the white balance also corresponds to the adjustment of the gain, the adjustment of the gain here refers to amplifying the image signal while a ratio of RGB is kept constant.

(Second Modification)

In the first exemplary embodiment, setting unit 71 of controller 7 sets the mode value of the plurality of temporary set values as the set value. By contrast, setting unit 71 may use an average value of the plurality of temporary set values as the set value.

Alternatively, setting unit 71 may set a median value of the plurality of temporary set values as the set value.

Alternatively, setting unit 71 may divide the plurality of temporary set values into a plurality of ranges, and may set a median value of the plurality of ranges as the set value. For example, in FIG. 6, the plurality of temporary set values (of the shutter speed) are divided into ranges r1 to r6. since ranges r3 and r4 are positioned between range r1 and range r6, ranges r3 and r4 correspond to median values of ranges r1 to r6. Therefore, setting unit 71 may set an upper limit value of range r3 (that is, a lower limit value of range r4) as the set value.

(Third Modification)

In the first exemplary embodiment, each of the plurality of imaging devices 2 determines the temporary set value, and controller 7 acquires the temporary set value from each of the plurality of imaging devices 2. By contrast, controller 7 may determine the temporary set value.

For example, each of the plurality of imaging devices 2 transmits, as the information regarding the detection result of sensor 3, the output signal (brightness value) of sensor 3 read by reading unit 41 to controller 7. Furthermore, each of the plurality of imaging devices 2 transmits the identification information of imaging device and information (first information) necessary for determining the temporary set value to controller 7. In addition, storage 72 of controller 7 stores other information (second information) necessary for determining the temporary set value in association with each of the plurality of imaging devices 2. Controller 7 can determine the temporary set value corresponding to each of the plurality of imaging devices 2 by referring to the output signal of sensor 3, the identification information of imaging device 2, the first information, and the second information.

The information necessary for determining the temporary set value includes, for example, a table indicating the correspondence between the output signal (brightness value) of sensor 3 and the temporary set value.

(Fourth Modification)

It is not essential that all imaging devices 2 among the plurality of imaging devices 2 transmit the information regarding the detection result of sensor 3 to controller 7. That is, two or more imaging devices 2 among the plurality of (all) imaging devices 2 may transmit the information regarding the detection result of each sensor 3 to controller 7. Controller 7 may determine the set value based on the information regarding the detection result of the sensor 3 acquired from the two or more imaging devices 2, and may transmit the set value to all imaging devices 2. Even in this case, since the set values of all imaging devices 2 are common, the properties of the plurality of images generated by all imaging devices 2 can be set to be close to each other.

In addition, temporary setting units 43 of the two or more imaging devices 2 may determine the temporary set value and may output the temporary set value to controller 7 as information regarding the detection result of sensor 3.

(Fifth Modification)

Controller 7 may group the plurality of imaging devices 2 into a plurality of groups. Furthermore, setting unit 71 may determine a set value to be applied to one group including a first number of imaging devices 2 based on the information regarding the detection result of the sensor 3 of a second number of imaging devices 2 belonging to the one group. Here, the second number is more than or equal to 2 and less than or equal to the first number. In the fifth modification, the second number is equal to the first number. When the second number is smaller than the first number, the content of the processing of determining the set value for each group is similar to the content in the fourth modification.

It is preferable that some or all of the plurality of groups do not overlap. That is, at least one any imaging device 2 belonging to one any group preferably belongs to only the one group among the plurality of groups.

For example, controller 7 preferably groups the plurality of imaging devices 2 into the plurality of groups based on the information regarding the detection result of sensor 3.

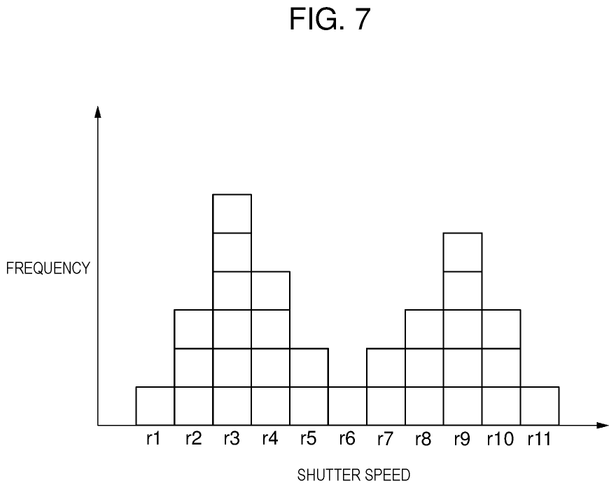

A specific example of grouping will be described with reference to FIG. 7. Controller 7 acquires the plurality of temporary set values (of the shutter speed) from the plurality of imaging devices 2 as the information regarding the detection result of sensor 3. When the plurality of temporary set values are represented in a frequency distribution diagram, a plurality of (two) peaks may appear with respect to the frequency as illustrated in FIG. 7. In FIG. 7, peaks appear in range r3 and range r9.

Hereinafter, imaging device 2 that has output the temporary set value belonging to range rM (M=1, 2, 3, . . . , and 11) is referred to as “imaging device 2 belonging to range rM”.

Controller 7 sets imaging devices 2 belonging to range r3 and a range near range r3 as imaging devices 2 belonging to a first group. In addition, controller 7 sets imaging devices 2 belonging to range r9 and a range near range r9 as imaging devices 2 belonging to a second group. For example, controller 7 groups the plurality of imaging devices 2 into the first group and the second group such that range r6 where the frequency is minimum is a boundary between the first group and the second group. That is, controller 7 sets imaging devices 2 belonging to ranges r1 to r5 as the first group, and sets imaging devices 2 belonging to ranges r6 to r11 as the second group. Note that imaging device 2 belonging to range r6 may belong to the first group.

Although the specific example of grouping has been described above, controller 7 may group the plurality of imaging devices 2 into three or more groups. In addition, depending on the information on the detection result of sensor 3, controller 7 may omit the processing of grouping. For example, in a case where only one frequency peak appears, controller 7 may omit the processing of grouping.

Any group among the plurality of groups is referred to as an Nth group (N is a natural number). Each of two or more imaging devices 2 belonging to the Nth group outputs information on the temporary set value. Hereinafter, these pieces of information are referred to as “two or more temporary set values of the Nth group”. Setting unit 71 of controller 7 determines a set value corresponding to the Nth group based on two or more temporary set values of the Nth group. For example, setting unit 71 sets the mode value of two or more temporary set values of the Nth group as the set value corresponding to the Nth group.

The set value corresponding to the Nth group is transmitted to two or more imaging devices 2 belonging to the Nth group. Two or more imaging devices 2 belonging to the Nth group set the settings regarding imaging based on the set value corresponding to the Nth group.

(Sixth Modification)

A sixth modification is a further modification of the fifth modification. In the sixth modification, controller 7 groups the plurality of imaging devices 2 into a plurality of groups based on a position of each of the plurality of imaging devices 2. That is, controller 7 sets two or more imaging devices 2 gathered in a specific region as one group.

A specific example of grouping will be described with reference to FIG. 3. In FIG. 3, a predetermined number (six in FIG. 3) of imaging devices 2 are arranged in a row in a vertical direction. In FIG. 3, a plurality of rows including a predetermined number of imaging devices 2 are arranged to surround imaging target T1. Controller 7 sets a predetermined number of imaging devices 2 arranged in a row as one group.

An example of the processing after the grouping is similar to the processing of the fifth modification.

Note that controller 7 may group the plurality of imaging devices 2 into a plurality of groups based on both the position of each of the plurality of imaging devices 2 and information regarding the detection result of sensor 3.

In addition, controller 7 may group the plurality of imaging devices 2 into a plurality of groups in accordance with an operation of an operator. For example, the operator may set two or more imaging devices 2 arranged in the shadow as a first group and may set remaining imaging devices 2 as a second group.

(Seventh Modification)

One imaging device 2 (hereinafter, referred to as a “master”) among the plurality of imaging devices 2 may have a function as controller 7. The master may acquire the information regarding the detection result of sensor 3 from remaining imaging devices 2 (hereinafter, referred to as “slaves”), may determine a set value based on the information, and may transmit the set value to the slaves.

Alternatively, two or more imaging devices 2 among the plurality of imaging devices 2 may have a function as controller 7. Any one of two or more imaging devices 2 selected by a user may enable the function as controller 7, and remaining imaging devices 2 may disable the function as controller 7.

(Eighth Modification)

Functions similar to the functions of imaging system 1, 3D model generation system 10, and controller 7 may be embodied by an imaging method, a (computer) program, a non-transitory recording medium recording the program, or the like.

A program according to one aspect is a program causing one or more processors (of controller 7) to execute acquisition processing, setting processing, and output processing. The acquisition processing is processing of acquiring the information regarding the detection result of sensor 3 that detects external brightness included in each of two or more imaging devices 2 among the plurality of imaging devices 2. The setting processing is processing of determining the common set value regarding imaging to be applied to the plurality of imaging devices 2 based on the information regarding the detection result acquired in the acquisition processing. The output processing is processing of outputting the set value determined in the setting processing to the plurality of imaging devices 2.

Each of imaging system 1 and 3D model generation system 10 according to the present disclosure includes a computer system. The computer system mainly includes a processor and a memory as hardware. At least some of the functions as imaging system 1 and 3D model generation system 10 according to the present disclosure are realized by the processor executing the program recorded in the memory of the computer system. The program may be recorded in advance in the memory of the computer system, may be provided through a telecommunication line, or may be provided by being recorded in a non-transitory recording medium such as a memory card, an optical disk, or a hard disk drive readable by the computer system. The processor of the computer system includes one or a plurality of electronic circuits including a semiconductor integrated circuit (IC) or a large-scale integration (LSI). The integrated circuit such as the IC or the LSI in this disclosure is called differently depending on a degree of integration, and includes an integrated circuit called a system LSI, a very large scale integration (VLSI), or an ultra large scale integration (ULSI). Furthermore, a field-programmable gate array (FPGA) programmed after manufacture of LSI, and a logical device capable of reconfiguring a joint relationship in LSI or reconfiguring circuit partitions in LSI can also be used as processors. The plurality of electronic circuits may be aggregated in one chip or may be provided in a distributed manner on a plurality of chips. The plurality of chips may be aggregated in one device or may be provided in a distributed manner in a plurality of devices. The computer system in this disclosure includes a microcontroller having at least one processor and at least one memory. Therefore, the microcontroller also includes one or a plurality of electronic circuits including a semiconductor integrated circuit or a large-scale integrated circuit.

In addition, the fact that the plurality of functions in imaging system 1 and 3D model generation system 10 are aggregated in one device is not an essential configuration for imaging system 1 and 3D model generation system 10. The components of imaging system 1 and 3D model generation system 10 may be dispersedly provided in a plurality of devices. Furthermore, at least a part of the functions of imaging system 1 and 3D model generation system 10, for example, at least a part of the function of 3D generation unit 73 may be realized by a cloud (cloud computing) or the like.

(Other Modifications)

Other modifications of the first exemplary embodiment will be described below. The following modifications may be realized by being combined as appropriate. In addition, the following modifications may be realized by being combined with the modifications described above as appropriate.

It is not essential that the plurality of imaging devices 2 are arranged to surround imaging target T1. For example, the plurality of imaging devices 2 may be arranged in a row in a horizontal direction or a vertical direction, or the plurality of imaging devices 2 may be arranged without a law.

In imaging system 1, it is not essential to generate the 3D model by using the pieces of information on the images generated by the plurality of imaging devices 2. The pieces of information on the images generated by the plurality of imaging devices 2 may not be particularly processed. Alternatively, a panoramic photo may be generated by using the pieces of information on the images generated by the plurality of imaging devices 2. That is, imaging system 1 may be a system that captures an identical subject from different angles by using the plurality of imaging devices 2 and stitches the same subject into one image.

It is not essential that the plurality of imaging devices 2 capture identical imaging target T1, and the plurality of imaging devices 2 may capture different imaging targets.

It is not essential that sensor 3 for detecting the external brightness of housing 20 also serves as a device (imaging element) for capturing imaging target T1 to generate an image, and the sensor may be provided separately from the imaging element.

Imaging setting unit 45 of the first exemplary embodiment uses the set value acquired from controller 7 as it is for the setting regarding imaging. By contrast, imaging setting unit 45 may correct the set value acquired from controller 7 based on the temporary set value, and may use the corrected set value for the setting regarding imaging.

In the first exemplary embodiment, when the imaging start command is input to controller 7, setting unit 71 determines the set value regarding imaging only once. By contrast, setting unit 71 may periodically determine the set value.

Imaging device 2 may have, as operation modes, an independent mode in which the setting regarding imaging is performed independently of controller 7 and imaging target T1 is captured, and a cooperative mode in which the setting regarding imaging is performed based on the set value acquired from controller 7 and imaging target T1 is captured. The operation of imaging device 2 described in the first exemplary embodiment corresponds to an operation in the cooperative mode.

Controller 7 may be provided separately from the plurality of imaging devices 2.

Setting unit 71 of controller 7 may further determine the set value based on additional information in addition to the information regarding the detection result of sensor 3 of each of at least some imaging devices 2 among the plurality of imaging devices 2. For example, an additional imaging device of which the setting of imaging is not performed by setting unit 71 may be installed, and setting unit 71 may determine the set value further based on information regarding a detection result (detection result of brightness) of a sensor of the additional imaging device.

### Second Exemplary Embodiment

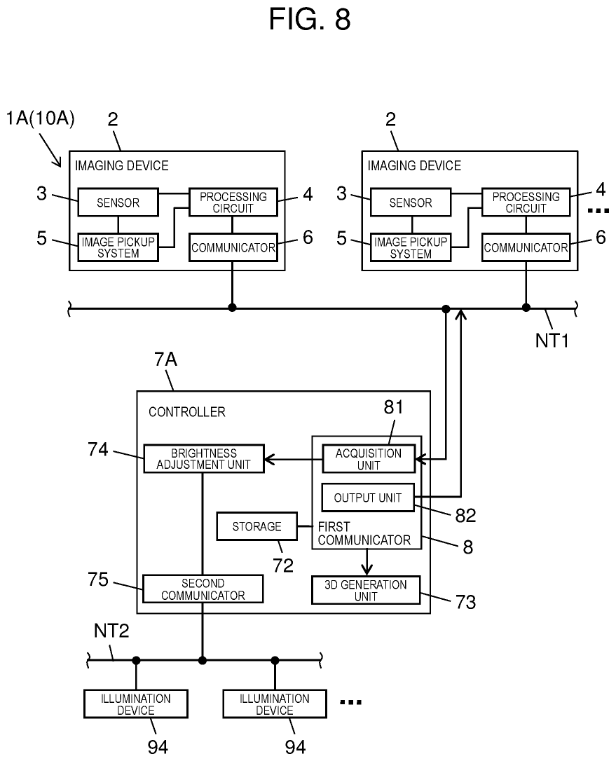

Hereinafter, imaging system 1A (3D model generation system 10A) according to a second exemplary embodiment will be described with reference to FIG. 8. The same reference marks are given to the same components as the components of the first exemplary embodiment, and the description thereof will be omitted. In addition, the configuration of the first exemplary embodiment (including the modifications) may be appropriately applied to the second exemplary embodiment.

As illustrated in FIG. 8, controller 7A of imaging system 1A includes brightness adjustment unit 74 instead of setting unit 71 (see FIG. 1). In addition, controller 7A includes second communicator 75 in addition to communicator 8 (referred to as “first communicator 8” in the present exemplary embodiment). Configurations of (first) communicator 8, storage 72, and 3D generation unit 73, and configurations of imaging devices 2 are the same as the configurations of the first exemplary embodiment. Note that brightness adjustment unit 74 merely indicates a function realized by controller 7A, and does not necessarily indicate a substantial configuration.

Second communicator 75 includes a communication interface for communicating with the plurality of illumination devices 94. Second communicator 75 can communicate with the plurality of illumination devices 94 via the communication interface. In the present exemplary embodiment, second communicator 75 exchanges signals with the plurality of illumination devices 94 via wireless communication network NT2. Note that first communicator 8 may also serve as second communicator 75. In addition, wireless communication network NT1 may also serve as wireless communication network NT2.

Controller 7A of the present exemplary embodiment does not execute processing of determining set values regarding imaging of the plurality of imaging devices 2. For example, the operator may input a set value appropriately determined by the operator to controller 7A, and controller 7A may transmit the input set value to the plurality of imaging devices 2.

Instead of determining the set value, controller 7A adjusts the brightness of each of the plurality of illumination devices 94 that illuminate a space captured by the plurality of imaging devices 2. More specifically, acquisition unit 81 acquires, as the information regarding the detection result of sensor 3, an output signal of sensor 3 (a signal regarding external brightness of housing 20) read by reading unit 41 from each of the plurality of imaging devices 2. Brightness adjustment unit 74 adjusts the brightness of each of the plurality of illumination devices 94 based on the information regarding the detection result of sensor 3 acquired by acquisition unit 81. Brightness adjustment unit 74 adjusts the brightness of each of the plurality of illumination devices 94 by transmitting a control signal to the plurality of illumination devices 94 via second communicator 75.

As an example, a target (brightness value) detected by sensor 3 is illuminance, and a target to be adjusted by brightness adjustment unit 74 is the brightness of each of the plurality of illumination devices 94.

Brightness adjustment unit 74 adjusts at least one of overall brightness of the plurality of illumination devices 94 and a brightness ratio. First, a case where brightness adjustment unit 74 adjusts the overall brightness of the plurality of illumination devices 94 will be described. In this case, brightness adjustment unit 74 adjusts the brightness of the plurality of illumination devices 94 such that the brightness ratio of the plurality of illumination devices 94 is kept constant or the amount of change in brightness is the same among the plurality of illumination devices 94.

Brightness adjustment unit 74 acquires the output signal (brightness value) of sensor 3 of each of the plurality of imaging devices 2 via acquisition unit 81. That is, brightness adjustment unit 74 acquires a plurality of brightness values corresponding one-to-one to the plurality of imaging devices 2. For example, brightness adjustment unit 74 obtains an average value of the plurality of brightness values, and compares an average value with a first threshold and a second threshold. The second threshold is larger than the first threshold. When the average value is less than the first threshold, brightness adjustment unit 74 increases the brightness of each of the plurality of illumination devices 94. On the other hand, when the average value is larger than the second threshold, brightness adjustment unit 74 decreases the brightness of each of the plurality of illumination devices 94. As a result, the brightness of the images generated by the plurality of imaging devices 2 can be adjusted to a predetermined range.

Next, a case where brightness adjustment unit 74 adjusts the brightness ratio of the plurality of illumination devices 94 will be described.

Brightness adjustment unit 74 acquires a brightness value and identification information of imaging device 2 from each of the plurality of imaging devices 2. That is, brightness adjustment unit 74 acquires a plurality of brightness values and a plurality of pieces of identification information corresponding one-to-one thereto. In addition, brightness adjustment unit 74 acquires pieces of positional information of the plurality of imaging devices 2 and pieces of positional information of the plurality of illumination devices 94 from storage 72.

Note that the pieces of positional information of the plurality of imaging devices 2 may be stored in advance in storage 72 or may be acquired from the plurality of imaging devices 2. The pieces of positional information of the plurality of illumination devices 94 may be stored in advance in storage 72 or may be acquired from the plurality of illumination devices 94.

In addition, storage 72 includes association information for associating the plurality of imaging devices 2 and the plurality of illumination devices 94. Each imaging device 2 is associated with illumination device 94 positioned near imaging device 2. The association information may be generated by controller 7A based on the pieces of positional information of the plurality of imaging devices 2 and the pieces of positional information of the plurality of illumination devices 94, or may be stored in advance in storage 72.

Brightness adjustment unit 74 adjusts the brightness of the plurality of illumination devices 94 based on a ratio between the plurality of brightness values. For example, in a case where a brightness value acquired from a certain imaging device 2 is larger than an average value of a plurality of brightness values by a predetermined value or more, brightness adjustment unit 74 darkens the brightness of illumination device 94 associated with imaging device 2 (that is, positioned near imaging device 2). In addition, in a case where the brightness value acquired from a certain imaging device 2 is smaller than the average value of the plurality of brightness values by the predetermined value or more, brightness adjustment unit 74 increases the brightness of illumination device 94 associated with imaging device 2. In order to generate the 3D model of imaging target T1, it is more preferable as variations in the plurality of brightness values acquired from the plurality of imaging devices 2 decreases.

According to imaging system 1A of the present exemplary embodiment, brightness adjustment unit 74 adjusts the brightness of the plurality of illumination devices 94. Thus, the quality (brightness) of the plurality of images generated by the plurality of imaging devices 2 can be improved, and the properties of the plurality of images generated by the plurality of imaging devices 2 can be set to be close to each other.

Note that brightness adjustment unit 74 may adjust the brightness of each of the plurality of illumination devices 94 based on the temporary set value determined by each of the plurality of imaging devices 2.

Note that, in the present exemplary embodiment, controller 7A may include setting unit 71 (see FIG. 1). That is, in addition to the processing of adjusting the brightness of each of the plurality of illumination devices 94, controller 7A may also perform processing of determining set values regarding imaging of the plurality of imaging devices 2.

### CONCLUSION

The following aspects are disclosed from the above-described exemplary embodiments and the like.

Imaging system (1 or 1A) according to a first aspect includes a plurality of imaging devices (2) and controller (7 or 7A). Controller (7 or 7A) communicates with the plurality of imaging devices (2). Each of the plurality of imaging devices (2) includes reception unit (61) and imaging setting unit (45). Reception unit (61) acquires a set value regarding imaging from controller (7 or 7A). Imaging setting unit (45) performs a setting regarding imaging based on the set value acquired by reception unit (61). Each of two or more imaging devices (2) among the plurality of imaging devices (2) further includes housing (20), sensor (3), and transmission unit (62). Sensor (3) detects external brightness of housing (20). Transmission unit (62) outputs information on a detection result of sensor (3) to controller (7 or 7A). Controller (7 or 7A) includes acquisition unit (81), setting unit (71), and output unit (82). Acquisition unit (81) acquires the information regarding the detection result of sensor (3) of each of two or more imaging devices (2). Setting unit (71) determines a common set value to be applied to the plurality of imaging devices (2) based on the information regarding the detection result acquired by acquisition unit (81). Output unit (82) outputs the set value determined by setting unit (71) to the plurality of imaging devices (2).

According to the above configuration, since the common set value regarding imaging is applied to the plurality of imaging devices (2), the imaging conditions of the plurality of imaging devices (2) can be set to be close to each other. As a result, it is possible to set properties (brightness, color tone, and the like) of a plurality of images generated by the plurality of imaging devices (2) to be close to each other. That is, a difference between the properties of the images generated by some imaging devices (2) and the properties of the images generated by other imaging devices (2) can be set to be relatively small.

In addition, in the imaging system (1 or 1A) according to a second aspect, in the first aspect, the set value includes a brightness set value regarding brightness of an image generated by imaging in each of the plurality of imaging devices (2).

According to the above configuration, the brightnesses of the plurality of images generated by the plurality of imaging devices (2) can be set to be close to each other.

In addition, in imaging system (1 or 1A) according to a third aspect, in the first or second aspect, the set value includes a color set value regrading a color of an image generated by imaging in each of the plurality of imaging devices (2).

According to the above configuration, the colors of the plurality of images generated by the plurality of imaging devices (2) can be set to be close to each other.

In addition, in imaging system (1 or 1A) according to a fourth aspect, in any one of the first to third aspects, each of two or more imaging devices (2) further includes temporary setting unit (43). Temporary setting unit (43) determines a temporary set value regarding imaging as the information regarding the detection result of sensor (3) based on the detection result of sensor (3). Setting unit (71) of controller (7 or 7A) determines the set value based on the temporary set value determined by temporary setting unit (43) of each of two or more imaging devices (2).

According to the above configuration, the amount of communication between the plurality of imaging devices (2) and controller (7 or 7A) can be reduced as compared with the case where controller (7 or 7A) determines the temporary set value or the corresponding amount.

In addition, in imaging system (1 or 1A) according to a fifth aspect, in the fourth aspect, setting unit (71) of controller (7 or 7A) sets, as the set value, a mode value of the temporary set value determined by temporary setting unit (43) of each of two or more imaging devices (2).

According to the above configuration, the set value suitable for imaging in the plurality of imaging devices (2) can be determined.

In addition, in imaging system (1 or 1A) according to a sixth aspect, in the fourth aspect, setting unit (71) of controller (7 or 7A) sets, as the set value, an average value of temporary set values determined by temporary setting units (43) of two or more imaging devices (2).

According to the above configuration, the set value suitable for imaging in the plurality of imaging devices (2) can be determined.

In addition, in imaging system (1 or 1A) according to a seventh aspect, in any one of the first to sixth aspects, controller (7 or 7A) groups the plurality of imaging devices (2) into a plurality of groups. Setting unit (71) determines a set value to be applied to one group including a first number of imaging devices (2) based on the information regarding the detection results of sensors (3) of a second number of imaging devices (2) belonging to the one group. The second number is more than or equal to 2 and less than or equal to the first number.

According to the above configuration, an appropriate set value can be determined for each group.

In addition, in imaging system (1 or 1A) according to an eighth aspect, in the seventh aspect, each of the plurality of imaging devices (2) includes sensor (3) and transmission unit (62). Controller (7 or 7A) groups the plurality of imaging devices (2) into a plurality of groups based on the information regarding the detection result of sensor (3).

According to the above configuration, the plurality of imaging devices (2) are grouped while referring to the detection results of sensors (3) of the plurality of imaging devices (2), and thus, an appropriate set value can be determined for each imaging device (2).

In addition, in imaging system (1 or 1A) according to a ninth aspect, in the seventh aspect, controller (7 or 7A) groups the plurality of imaging devices (2) into a plurality of groups based on a position of each of the plurality of imaging devices (2).

According to the above configuration, the plurality of imaging devices (2) are grouped while referring to the positions of the plurality of imaging devices (2), and thus, an appropriate set value can be determined for each imaging device (2).

In addition, in imaging system (1 or 1A) according to a tenth aspect, in any one of the first to ninth aspects, controller (7 or 7A) further includes brightness adjustment unit (74). Brightness adjustment unit (74) adjusts brightness of each of a plurality of illumination devices (94) that illuminates a space (SP1) captured by a plurality of imaging devices (2) based on the information regarding the detection result acquired by acquisition unit (81).

According to the above configuration, the brightnesses of the plurality of illumination devices (94) are adjusted, and space (SP1) captured by the plurality of imaging devices (2) can be set to have appropriate brightness. As a result, the properties of the plurality of images generated by the plurality of imaging devices (2) can be set to be close to each other.

In addition, imaging system (1 or 1A) according to an eleventh aspect includes a plurality of imaging devices (2) and controller (7 or 7A). Controller (7 or 7A) communicates with the plurality of imaging devices (2). Each of two or more imaging devices (2) among the plurality of imaging devices (2) includes housing (20), sensor (3), and transmission unit (62). Sensor (3) detects external brightness of housing (20). Transmission unit (62) outputs information on a detection result of sensor (3) to controller (7 or 7A). Controller (7 or 7A) includes acquisition unit (81) and brightness adjustment unit (74). Acquisition unit (81) acquires the information regarding the detection result of sensor (3) of each of two or more imaging devices (2). Brightness adjustment unit (74) adjusts brightness of each of a plurality of illumination devices (94) that illuminates a space (SP1) captured by a plurality of imaging devices (2) based on the information regarding the detection result acquired by acquisition unit (81).

According to the above configuration, the brightnesses of the plurality of illumination devices (94) are adjusted, and space (SP1) captured by the plurality of imaging devices (2) can be set to have appropriate brightness. As a result, the properties of the plurality of images generated by the plurality of imaging devices (2) can be set to be close to each other.

The configurations according to the first or eleventh aspect are not essential configurations for imaging system (1 or 1A), and can be omitted as appropriate.

In addition, 3D model generation system (10 or 10A) according to a twelfth aspect includes imaging system (1 or 1A) according to any one of the first to eleventh aspects and 3D generation unit (73). 3D generation unit (73) generates a 3D model of an imaging target (T1) of a plurality of imaging devices (2) by using information of a plurality of images generated by the plurality of imaging devices (2) of imaging system (1 or 1A).

According to the above configuration, the quality of the 3D model can be improved.

In addition, controller (7 or 7A) according to a thirteenth aspect includes acquisition unit (81), setting unit (71), and output unit (82). Acquisition unit (81) acquires information regarding a detection result of sensor (3) that detects external brightness included in each of two or more imaging devices (2) among a plurality of imaging devices (2). Setting unit (71) determines a common set value regarding imaging to be applied to a plurality of imaging devices (2) based on the information regarding the detection result acquired by acquisition unit (81). Output unit (82) outputs the set value determined by setting unit (71) to the plurality of imaging devices (2).

According to the above configuration, it is possible to set properties (brightness, color tone, and the like) of a plurality of images generated by a plurality of imaging devices (2) to be close to each other.

In addition, a program according to a fourteenth aspect is a program causing one or more processors to execute acquisition processing, setting processing, and output processing. The acquisition processing is processing of acquiring information regarding a detection result of sensor (3) that detects external brightness included in each of two or more imaging devices (2) among the plurality of imaging devices (2). The setting processing is processing of determining a common set value regarding imaging to be applied to the plurality of imaging devices (2) based on the information regarding the detection result acquired in the acquisition process. The output processing is processing of outputting the set value determined in the setting processing to the plurality of imaging devices (2).

According to the above configuration, it is possible to set properties (brightness, color tone, and the like) of a plurality of images generated by a plurality of imaging devices (2) to be close to each other.

Various configurations (including modifications) of imaging system (1 or 1A) and 3D model generation system (10 or 10A) according to the exemplary embodiments are not limited to the above aspects, and can be embodied by a method and a program.

### REFERENCE MARKS IN THE DRAWINGS

1, 1A: imaging system

2: imaging device

3: sensor

7, 7A: controller

10, 10A: 3D model generation system

20: housing

43: temporary setting unit

45: imaging setting unit

61: reception unit

62: transmission unit

71: setting unit

73: 3D generation unit

74: brightness adjustment unit

81: acquisition unit

82: output unit

94: illumination device

T1: imaging target

1. An imaging system comprising:
a plurality of imaging devices that include two or more imaging devices; and
a controller that communicates with the plurality of imaging devices,
wherein each of the plurality of imaging devices includes:
a reception unit that acquires, from the controller, a common set value regarding imaging, and
an imaging setting unit that performs a setting regarding the imaging based on the common set value acquired by the reception unit,
each of the two or more imaging devices further includes:
a housing,
a sensor that detects external brightness of the housing, and
a transmission unit that outputs information regarding a detection result of the sensor to the controller, and
the controller includes:
an acquisition unit that acquires the information regarding the detection result of the sensor of each of the two or more imaging devices,
a setting unit that determines the common set value to be applied to the plurality of imaging devices based on the information regarding the detection result acquired by the acquisition unit, and
an output unit that outputs the common set value determined by the setting unit to the plurality of imaging devices.

2. The imaging system according to claim 1, wherein the common set value includes a brightness set value regarding brightness of an image generated by the imaging in each of the plurality of imaging devices.

3. The imaging system according to claim 1, wherein the common set value includes a color set value regarding a color of an image generated by the imaging in each of the plurality of imaging devices.

4. The imaging system according to claim 1,
wherein each of the two or more imaging devices further includes a temporary setting unit that determines, as the information regarding the detection result of the sensor, a temporary set value regarding the imaging based on the detection result of the sensor, and
the setting unit of the controller determines the common set value based on the temporary set value determined by the temporary setting unit of each of the two or more imaging devices.

5. The imaging system according to claim 4, wherein the setting unit of the controller determines, as the common set value, a mode value of two or more temporary set values determined by the two or more imaging devices.

6. The imaging system according to claim 4, wherein the setting unit of the controller determines, as the common set value, an average value of two or more temporary set values determined by the two or more imaging devices.

7. The imaging system according to claim 1,
wherein the controller groups the plurality of imaging devices into a plurality of groups,
the setting unit determines the common set value to be applied to one group including a first number of imaging devices based on the information regarding the detection result of the sensor of each of a second number of imaging devices belonging to the one group, and
the second number is more than or equal to 2, and is less than or equal to the first number.

8. The imaging system according to claim 7,
wherein each of the plurality of imaging devices includes the sensor and the transmission unit, and
the controller groups the plurality of imaging devices into the plurality of groups based on the information regarding the detection result of the sensor.

9. The imaging system according to claim 7, wherein the controller groups the plurality of imaging devices into the plurality of groups based on a position of each of the plurality of imaging devices.

10. The imaging system according to claim 1,
wherein each of the plurality of imaging devices includes:
the sensor;
the transmission unit, and
a temporary setting unit that determines a temporary set value regarding the imaging as the information regarding the detection result of the sensor based on the detection result of the sensor, and
wherein the controller groups the plurality of imaging devices into a plurality of groups based on the temporary set value determined by the temporary setting unit of each of the plurality of imaging devices.

11. The imaging system according to claim 10,
wherein the temporary setting unit determines a temporary set value regarding a shutter speed of the imaging as the temporary set value regarding the imaging, and
the controller groups the plurality of imaging devices into the plurality of groups based on the temporary set value regarding the shutter speed of the imaging.

12. The imaging system according to claim 1, wherein the controller further includes a brightness adjustment unit that performs adjustment of brightness of each of a plurality of illumination devices that illuminate a space to be captured by the plurality of imaging devices based on the information regarding the detection result acquired by the acquisition unit.

13. An imaging system comprising:
a plurality of imaging devices that include two or more imaging devices; and
a controller that communicates with the plurality of imaging devices,
wherein each of the two or more imaging devices includes:
a housing,
a sensor that detects external brightness of the housing, and
a transmission unit that outputs information regarding a detection result of the sensor to the controller, and
the controller includes:
an acquisition unit that acquires the information regarding the detection result of the sensor of each of the two or more imaging devices, and
a brightness adjustment unit that performs adjustment of brightness of each of a plurality of illumination devices that illuminate a space to be captured by the plurality of imaging devices based on the information regarding the detection result acquired by the acquisition unit.

14. A 3D model generation system comprising:
the imaging system according to claim 1; and
a 3D generation unit that generates a 3D model of an imaging target of the plurality of imaging devices by using pieces of information on a plurality of images generated by the plurality of imaging devices of the imaging system.

15. A controller comprising:
an acquisition unit that acquires information regarding a detection result of a sensor that detects external brightness, the sensor being included in each of two or more imaging devices among a plurality of imaging devices;
a setting unit that determines a common set value regarding imaging based on the information regarding the detection result acquired by the acquisition unit, the common set value being applied to the plurality of imaging devices; and
an output unit that outputs the common set value determined by the setting unit to the plurality of imaging devices.

16. A method comprising:
acquiring information regarding a detection result of a sensor that detects external brightness, the sensor being included in each of two or more imaging devices among a plurality of imaging devices;
determining a common set value regarding imaging based on the information regarding the detection result acquired by the acquiring, the common set value being applied to the plurality of imaging devices; and
outputting the common set value determined by the determining to the plurality of imaging devices.

17. A non-transitory computer readable medium storing a program causing one or more processors to execute the method according to claim 16.
